(19) United States
(12) Patent Application Publication
(10) Pub. No.: US 2015/0136096 A1
(43) Pub. Date: May 21, 2015

(54) INTERNAL COMBUSTION ENGINE

(71) Applicant: Jumpei Shioda, Susono-shi (JP)

(72) Inventor: Jumpei Shioda, Susono-shi (JP)

(73) Assignee: TOYOTA JIDOSHA KABUSHIKI KAISHA, Toyota-shi (JP)

(21) Appl. No.: 14/399,315

(22) PCT Filed: May 8, 2012
(86) PCT No.: PCT/JP2012/061760

§ 371 Date: Nov. 6, 2014

(51) Int. Cl. F01M 13/04; F01M 13/02; F02M 25/07

(52) U.S. Cl. CPC F01M 13/04; F02M 25/072; F01M 13/028
USPC 123/568.14; 123/574

(57) ABSTRACT

When a blow-by gas collides with an outer circumferential wall of a tubular member, part of oil mist in the collision gas is liquefied (an oil droplet). The oil droplet takes in the oil mist in the blow-by gas which flows into an intake pipe in succession, and moves on the outer circumferential wall of the tubular member in accordance with a flow of an intake gas and the gravity while keeping a liquefied state. The oil droplet flows in from an inlet section while keeping the liquefied state, and uniformly flows into a surface of an impeller to be discharged to a scroll side. A surface of a diffuser is washed uniformly by the oil droplet keeping the liquefied state, and generation or accumulation of the deposit on the surface can be restrained.

### TECHNICAL FIELD

The present invention relates to an internal combustion engine, and more particularly relates to an internal combustion engine that is equipped with a blow-by gas returning mechanism.

### BACKGROUND ART

There has been conventionally known a blow-by gas returning mechanism that reintroduces a gas which flows into a crankcase from a gap between the piston and the cylinder wall surface of an internal combustion engine by way of a PCV (Positive Crankcase Ventilation) pipe and an intake pipe. For example, Patent Literature 1 discloses the blow-by gas returning mechanism that includes a first PCV pipe which connects a cylinder head and an intake pipe, at a downstream side from a throttle valve, and a second PCV pipe which connects the cylinder head and the intake pipe at an upstream side from a compressor. According to the blow-by gas returning mechanism of Patent Literature 1 described above, a blow-by gas is reintroduced into an internal combustion engine by two paths that are the first PCV pipe and the second PCV pipe and can be combusted.

### CITATION LIST

### Patent Literature

Patent Literature 1: Japanese Patent Laid-Open No. 2009-293464
Patent Literature 2: Japanese Patent Laid-Open No. 2009-281317
Patent Literature 3: Japanese Patent Laid-Open No. 2004-116292
Patent Literature 4: Japanese Patent Laid-Open No. 2009-264158
Patent Literature 5: Japanese Patent Laid-Open No. 2005-048734

### SUMMARY OF INVENTION

### Problem to be solved by the Invention

Incidentally, in a blow-by gas, soot derived from carbon fuel, and oil in a crankcase are contained. Most of the oil exists in the blow-by gas with the above described soot taken inside the oil. Therefore, when the blow-by gas is introduced, the soot-containing oil contacts and adheres to the intake pipe inner wall and the other intake system components, and turns into deposits and accumulates as a result. Accumulation of deposits leads to reduction in the intake performance, and ultimately to reduction in the engine performance. Therefore, as for soot-containing oil, it is desirable that the generation of the soot-containing oil can be restrained.

In this regard, in Patent Literature 1 described above, a removal device that removes the oil in a blow-by gas is provided in the second PCV pipe. However, even if the removal device is used, complete removal of the oil is difficult, and the soot-containing oil flows into the intake pipe. In particular, oil mist of a particle size equal to or smaller than 1 μm (hereinafter, called “oil mist with a small particle size”) is difficult to capture by the removing device, and has the property of being easily evaporated because of the small particle size in addition. Therefore, when the soot-containing oil flows into the intake pipe as oil mist with a small particle size, and contacts and adheres to the intake pipe inner wall and the like, the soot-containing oil turns into deposits with a high probability. As above, for solution to the deposits derived from the oil mist with a small particle size, further improvement has been required.

The present invention is made in the light of the aforementioned problem, and has an object to provide an internal combustion engine capable of restraining generation or accumulation of deposits derived from oil mist.

### Means for Solving the Problem

To achieve the above described object, a first aspect of the present invention is an internal combustion engine, comprising:

a PCV pipe that introduces a blow-by gas containing oil into an intake pipe of the internal combustion engine; and

particle size enlargement oil flowing means for enlarging a particle size of the oil in the blow-by gas introduced into the intake pipe from the PCV pipe, and causing the oil having the particle size enlarged to flow along an inner circumferential wall of the intake pipe.

A second aspect of the present invention is the internal combustion engine according to the first aspect,

wherein the particle size enlargement oil flowing means comprises an intake pipe internal member having an outer circumferential wall in a curved shape that is disposed on a blow-by gas passage in which the blow-by gas introduced into the intake pipe flows,

the PCV pipe is connected to the intake pipe from above in a vertical direction, and

an opening of the PCV pipe to the intake pipe, and the outer circumferential wall are disposed to face each other.

A third aspect of the present invention is the internal combustion engine according to the second aspect, further comprising:

a compressor that is connected to the intake pipe at a downstream side from the intake pipe internal member, and compresses a gas flowing in the intake pipe.

A fourth aspect of the present invention is the internal combustion engine according to the second or the third aspect,

wherein flowability reducing means that reduces flowability on the outer circumferential wall, of the oil in the blow-by gas introduced into the intake pipe is provided at the outer circumferential wall.

A fifth aspect of the present invention is the internal combustion engine according to the fourth aspect,

wherein the flowability reducing means is a plurality of means that extends in an upstream and downstream directions of the intake pipe, and are spaced from one another in a circumferential direction of the outer circumferential wall.

A sixth aspect of the present invention is the internal combustion engine according to any one of the second to the fifth aspects, further comprising:

an EGR pipe that introduces an EGR gas into the intake pipe from an upstream side from an opening of the PCV pipe to the intake pipe,

wherein the intake pipe internal member is an internal piping with a smaller diameter than the intake pipe, and

an upstream end opening of the internal piping opens toward an opening of the EGR pipe to the intake pipe.

### Advantageous Effect of Invention

According to the first invention, by the particle size enlargement oil flowing means, the oil in the blow-by gas can be caused to flow along the inner circumferential wall of the intake pipe while the particle size of the oil is enlarged. The oil mist in the blow-by gas is increased in viscosity by losing the oil component inside the oil mist, and easily adheres to the intake pipe inner wall and the like at the time of contacting the intake pipe inner wall and the like. In this regard, if the particle size of the oil can be enlarged by the particle size enlargement oil flowing means, the viscosity increasing speed can be slowed down. Accordingly, adherence of the oil mist to the intake pipe inner wall and the like can be restrained. Consequently, according to the first invention, deposit generation can be restrained. Further, the oil with an enlarged particle size in which the oil particle size is enlarged can take the oil with a small particle size inside the oil with an enlarged particle size. Therefore, if the oil with an enlarged particle size flows along the inner circumferential wall of the intake pipe, the oil with an enlarged particle size can uniformly wash and remove the oil which adheres to and is being deposited on a midpoint in the passage. Consequently, according to the first invention, accumulation of the deposits also can be restrained.

According to the second invention, the intake pipe internal member having the outer circumferential wall in a curved shape is disposed on the blow-by gas passage, and therefore, the blow-by gas can be caused to flow along the outer circumferential wall. Further, the PCV pipe is connected to the above described intake pipe from above in the vertical direction, and further, the opening of the PCV pipe to the intake pipe, and the above described outer circumferential wall are disposed to face each other. Therefore, the above described oil with an enlarged particle size is generated on the above described outer circumferential wall, and can be caused to flow uniformly along the above described outer circumferential wall in accordance with the flow of the blow-by gas and the gravity.

In the internal combustion engine including a compressor, the blow-by gas is compressed by the compressor. Therefore, the inside of the above described compressor can be said to be under the environment where the viscosity of the oil mist in the blow-by gas is easily increased. In this regard, according to the third invention, the intake pipe internal member having the outer circumferential wall in a curved shape is disposed on the above described blow-by gas passage at the upstream side from the compressor, and therefore, the oil with an enlarged particle size in which the oil particle size is enlarged is caused to flow uniformly along the above described outer circumferential wall and can be introduced into the above described compressor. Accordingly, generation and accumulation of deposits inside the compressor can be restrained.

According to the fourth invention, by the flowability reducing means, flowability of the oil on the above described outer circumferential wall can be reduced. If the flowability of the oil can be reduced, enlargement of the particle size of the oil particle can be promoted before contact to the intake pipe inner wall and the like. Consequently, according to the present invention, the oil particle size can be reliably enlarged.

As described above, the above described oil with an enlarged particle size flows along the above described outer circumferential wall in accordance with the flow of the blow-by gas and the gravity. According to the fifth invention, the above described flowability reducing means corresponds to a plurality of means which extend in the upstream and downstream directions of the above described intake pipe, and are spaced from one another along the above described outer circumferential wall, and therefore, mobility of the blow-by gas in the flow direction and mobility of the blow-by gas in the vertical direction can be balanced. Accordingly, the above described oil with an enlarged particle size can be caused to flow more uniformly along the above described outer circumferential wall.

When the EGR pipe which introduces the EGR gas to the above described intake pipe from the upstream side from the opening of the above described PCV pipe to the above described intake pipe is included, the EGR gas is introduced into the above described intake pipe from the upstream side from the blow-by gas. Here, the EGR gas is a high-temperature gas, and therefore, if the EGR gas mixes with the blow-by gas, the oil mist in the blow-by gas easily increases in viscosity. In this regard, according to the sixth invention, the upstream end opening of the internal piping with a smaller diameter than the intake pipe is opened toward the opening of the EGR pipe to the intake pipe, and therefore, the EGR gas can be introduced into the above described internal piping. Accordingly, the EGR gas and the blow-by gas can be prevented from mixing with each other, and therefore, increase in the viscosity of the oil mist can be prevented.

### BRIEF DESCRIPTION OF DRAWINGS

FIG. 1 is a diagram for explaining a system configuration of embodiment 1.

FIG. 2 is an enlarged sectional view of a vicinity of the compressor 12b in FIG. 1.

FIG. 3 is an enlarged sectional view of the vicinity of the compressor 12b in FIG. 1.

FIG. 4 is a sectional view taken along line A-A in FIG. 3.

FIG. 5 is a view for explaining the behavior of the oil droplet 38 inside the compressor 12b.

FIG. 6 is a diagram for explaining the generation mechanism of a deposit.

FIG. 7 is a diagram for explaining the behavior of the oil mist in the diffuser 32.

FIG. 8 is a diagram for explaining a behavior of oil mist of a large particle size in the diffuser 32.

FIG. 9 is a view for explaining a flow of a blow-by gas and the like in a conventional intake system structure.

FIG. 10 is a view for explaining a behavior of the oil droplet 56 inside a compressor 58.

FIG. 11 is a view for explaining a modified mode of embodiment 1 described above.

FIG. 12 is a view for explaining the feature part of the tubular member in embodiment 2, and an effect by the feature part.

FIG. 13 is a view for explaining a modified mode of embodiment 2.

FIG. 14 is a view for explaining the feature part of the tubular member in embodiment 3, and an effect by the feature part.

FIG. 15 is a view for explaining the feature part of the tubular member in embodiment 4, and an effect by the feature part.

FIG. 16 is a view for explaining a problem of the tubular member 70 of embodiment 3.

FIG. 17 is a diagram for explaining the system configuration of embodiment 5.

FIG. 18 is an enlarged sectional view of a vicinity of the compressor 12b in FIG. 17.

FIG. 19 is a sectional view taken along line A-A′ of FIG. 18.

FIG. 20 is a view showing a temperature distribution inside the compressor 12b at the time of introduction of the LPL-EGR gas.

### DESCRIPTION OF EMBODIMENTS

### Embodiment 1

### Explanation of System Configuration

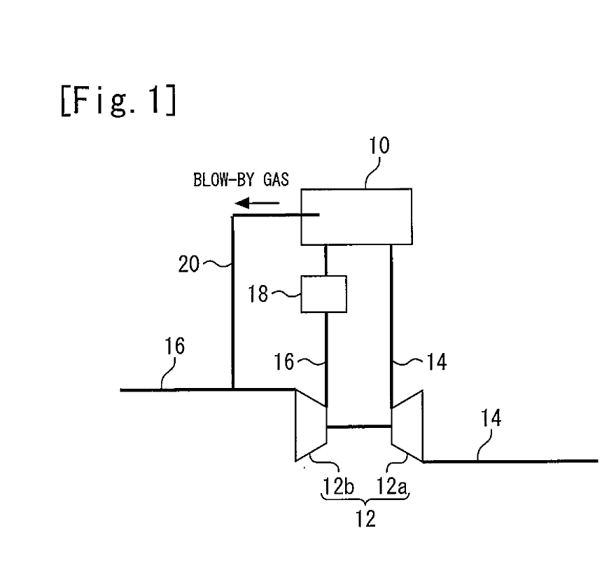

First, with reference to FIG. 1 to FIG. 11, embodiment 1 of the present invention will be described. FIG. 1 is a diagram for explaining a system configuration of embodiment 1. As shown in FIG. 1, a system of the present embodiment includes an engine 10 as an internal combustion engine. Each of cylinders of the engine 10 is provided with a piston, an intake valve, an exhaust valve, fuel injector and the like. Note that the number of cylinders and disposition of the cylinders of the engine 10 are not specially limited.

Further, the system of the present embodiment includes a turbocharger 12. The turbocharger 12 includes a turbine 12a provided at an exhaust pipe 14, and a compressor 12b provided at an intake pipe 16. The turbine 12a and the compressor 12b are connected to each other. At a time of operation of the turbocharger 12, the turbine 12a receives an exhaust pressure and rotates, whereby the compressor 12b is driven, and a gas flowing into the compressor 12b is compressed. The intake pipe 16 is provided with an intercooler 18 that cools the compressed gas.

Further, the system of the present embodiment includes a blow-by gas returning mechanism which returns a blow-by gas. A blow-by gas is a gas that flows into a crankcase from a gap between the piston and a cylinder wall surface of the engine 10. The blow-by gas returning mechanism includes a PCV pipe 20. The PCV pipe 20 connects the intake pipe 16 at an upstream side from the compressor 12b and a cylinder head cover (not illustrated) of the engine 10. The blow-by gas flows in the PCV pipe 20 and the intake pipe 16 in this sequence, and thereby is reintroduced into the engine 10.

### Feature of Embodiment 1

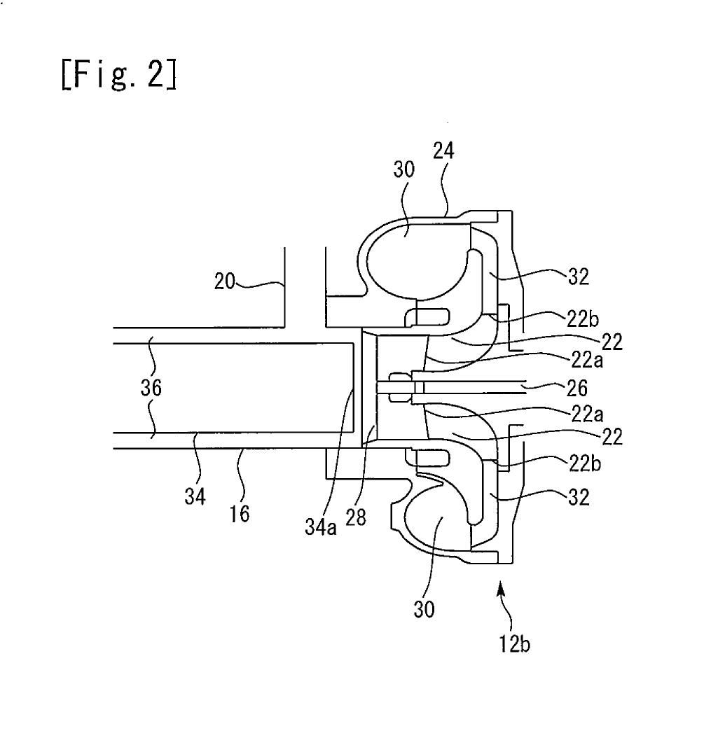

Next, with reference to FIG. 2 to FIG. 10, a feature of the present embodiment will be described. First, with reference to FIG. 2, a structure of an intake system corresponding to a feature part of the present embodiment will be described. FIG. 2 is an enlarged sectional view of a vicinity of the compressor 12b in FIG. 1. As shown in FIG. 2, the compressor 12b includes an impeller 22, a housing 24 and a connecting shaft 26. The housing 24 rotatably supports the connecting shaft 26 which supports the impeller 22 to be incapable of rotating. The housing 24 is provided with an inlet section 28 that introduces intake air to an intake side 22a of the impeller 22, a spiral scroll 30 that is disposed on an outer periphery of the impeller 22, and a diffuser 32 that allows a discharge side 22b of the impeller 22 and the scroll 30 to communicate with each other. The connecting shaft 26 is connected to a turbine wheel (not illustrated) of the turbine 12a.

Further, as shown in FIG. 2, a tubular member 34 is disposed inside the intake pipe 16. The tubular member 34 and the intake pipe 16 are disposed in such a manner that center axes thereof correspond to each other. Thereby, a gap 36 is formed between the tubular member 34 and the intake pipe 16. In order to form the gap 36 like this, as the tubular member 34, a tubular member with an outside diameter thereof having a size of 85% to approximately 99% of an inside diameter of the intake pipe 16 is preferably used. Use of the tubular member 34 of the size like this would be preferable, because oil droplets (described later) are easily caused to flow along an outer circumferential wall of the tubular member 34. A downstream end 34a of the tubular member 34 is disposed to face the inlet section 28.

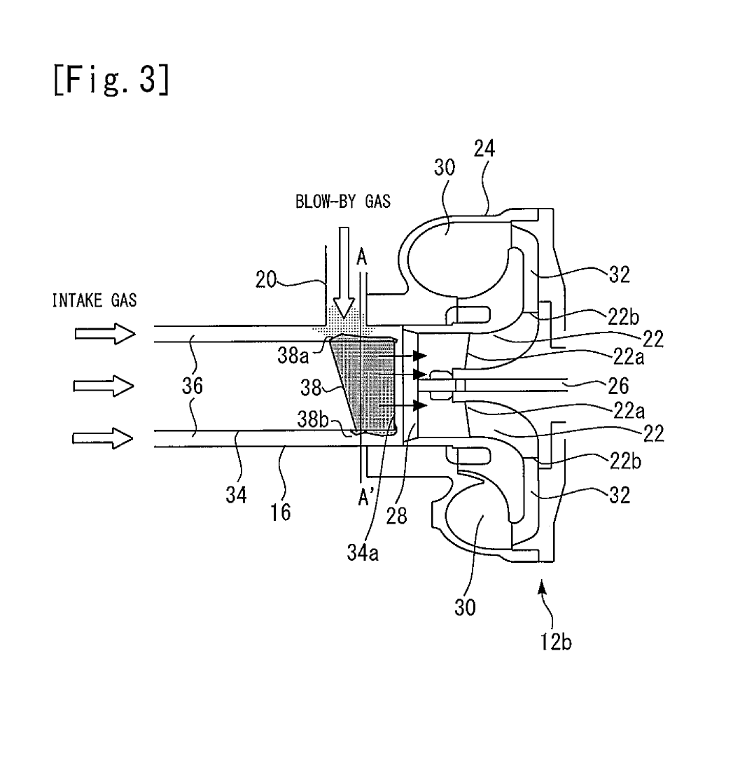

Subsequently, with reference to FIG. 3 to FIG. 5, a flow of the blow-by gas and the like in an intake system structure in FIG. 2 will be described. FIG. 3 is an enlarged sectional view of the vicinity of the compressor 12b in FIG. 1. As shown by the arrows in FIG. 3, the blow-by gas which flows into the intake pipe 16 from the PCV pipe 20 flows to the inlet section 28 side together with an intake gas that flows in the gap 36. At this time, the blow-by gas collides with the outer circumferential wall of the tubular member 34, and thereafter, flows in such a manner as to be along the outer circumferential wall (an inner circumferential wall of the intake pipe 16) of the tubular member 34.

Here, as described above, oil mist that is a result of the oil in the crankcase being turned into mist is contained in the blow-by gas. The oil mist mentioned here is oil of a particle size equal to or smaller than approximately 5 μm. When the blow-by gas collides with the outer circumferential wall of the tubular member 34, part of the oil mist in the colliding gas is liquefied (oil droplet 38). The oil droplet 38 takes in the oil mist in the blow-by gas which flows into the intake pipe 16 in succession, and moves on the outer circumferential wall of the tubular member 34 in accordance with the flow of the intake gas and the gravity while keeping the liquefied state. Note that oil droplets 38a and 38b shown in FIG. 3 schematically show temporary accumulation states of the oil droplet 38.

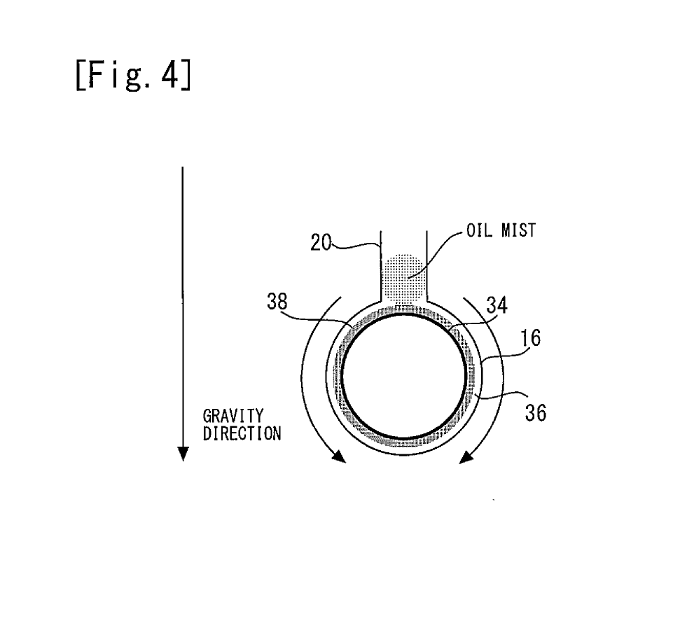

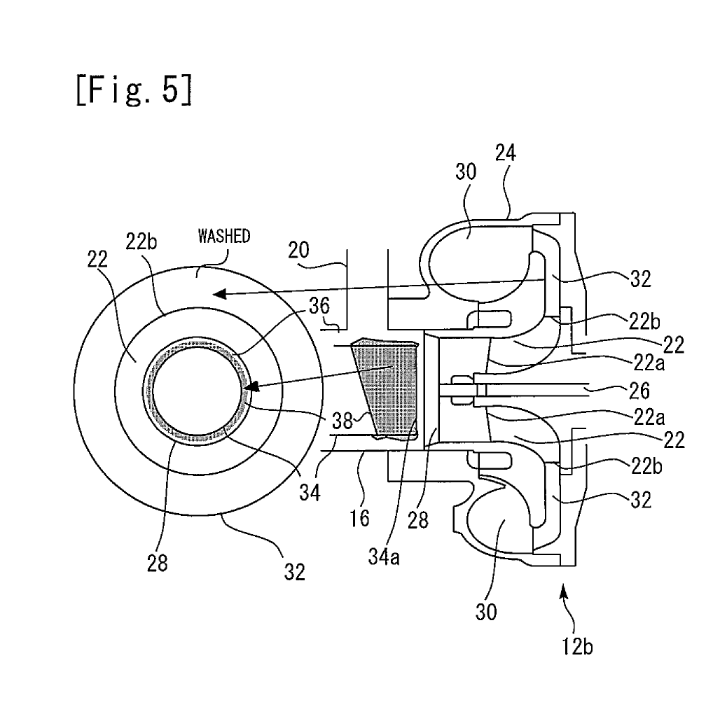

With reference to FIG. 4 and FIG. 5, a flow of the oil droplet 38 in the intake system structure in FIG. 2 will be described in detail. First, with reference to FIG. 4, a behavior of the oil droplet 38 in the outer circumferential wall of the tubular member 34 will be described. FIG. 4 is a sectional view taken along line A-A in FIG. 3. As shown in FIG. 4, the PCV pipe 20 is connected to the intake pipe 16 from above in the gravitation direction (namely, above in the vertical direction). Therefore, the oil droplet 38 which is generated by collision of the blow-by gas flows down on the outer circumferential wall of the tubular member 34 in accordance with the gravity, and diffuses to the entire outer circumferential wall while keeping the liquefied state.

FIG. 5 is a view for explaining the behavior of the oil droplet 38 inside the compressor 12b. As described in FIG. 4, the oil droplet 38 diffuses to the entire outer circumferential wall of the tubular member 34 while keeping the liquefied state. Therefore, the oil droplet 38 flows in from the inlet section 28 while keeping the liquefied state, and flows uniformly into a surface of the impeller 22 to be discharged to the scroll 30 side. Consequently, according to the intake system structure of FIG. 2, the surface of the diffuser 32 is washed uniformly by the oil droplet 38 which keeps the liquefied state, and generation or accumulation of deposits on the surface can be restrained.

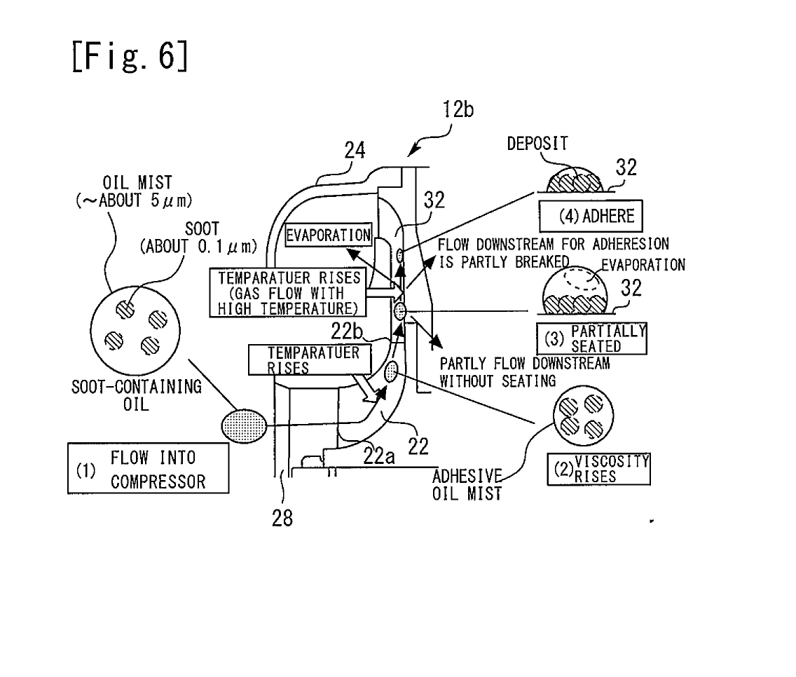

An effect by the intake system structure in FIG. 2 described above will be described with reference to FIG. 6 to FIG. 10. First, with reference to FIG. 6 to FIG. 8, a generation mechanism of a deposit, and a behavior of oil mist in the diffuser 32 will be described. FIG. 6 is a diagram for explaining the generation mechanism of a deposit. As described several times, the oil in the crankcase is contained in the blow-by gas. A lot of oil mist is contained in the oil. This is because the blow-by gas immediately after discharged from the cylinder head has a high temperature, and part of the oil in the blow-by gas exists in a gaseous state, and is turned into mist during flowing through the PCV pipe 20.

Further, in the oil mist, soot-containing oil which takes soot with a particle size of approximately 0.1 μm inside the soot-containing oil is present. The oil mist shown in FIG. 6 schematically shows the soot-containing oil like this. As shown in FIG. 6, the soot-containing oil flows into the compressor 12b from the inlet section 28 ((1) in FIG. 6). At this time, the particle size of the soot-containing oil is equal to or smaller than approximately 5 μm. Here, the gas which flows into the compressor 12b (namely, the gas containing the intake gas and the blow-by gas) is compressed to be raised in temperature at once when passing through the impeller 22 after passing through the inlet section 28, and is further raised in temperature in a compression region called the diffuser 32. Therefore, along with increase in temperature of the internal inflow gas, an internal temperature of the soot-containing oil also increases. Therefore, the soot-containing oil loses an oil component therein by evaporation, and the particle size of the soot-containing oil is gradually reduced.

Namely, as shown in FIG. 6, in a vicinity of the discharge side 22b, the soot-containing oil loses the oil component by evaporation along with increase in the temperature of the internal inflow gas, and is reduced in the particle size and is increased in viscosity ((2) in FIG. 6). The soot-containing oil which is reduced in the particle size and increased in viscosity is seated on the surface of the diffuser 32, or further flows to a downstream side without being seated ((3) in FIG. 6). Subsequently, the soot-containing oil which further flows to the downstream side loses most of the oil component inside the soot-containing oil ((4) in FIG. 6). In this manner, the soot-containing oil adheres to the surface of the diffuser 32 to be a deposit.

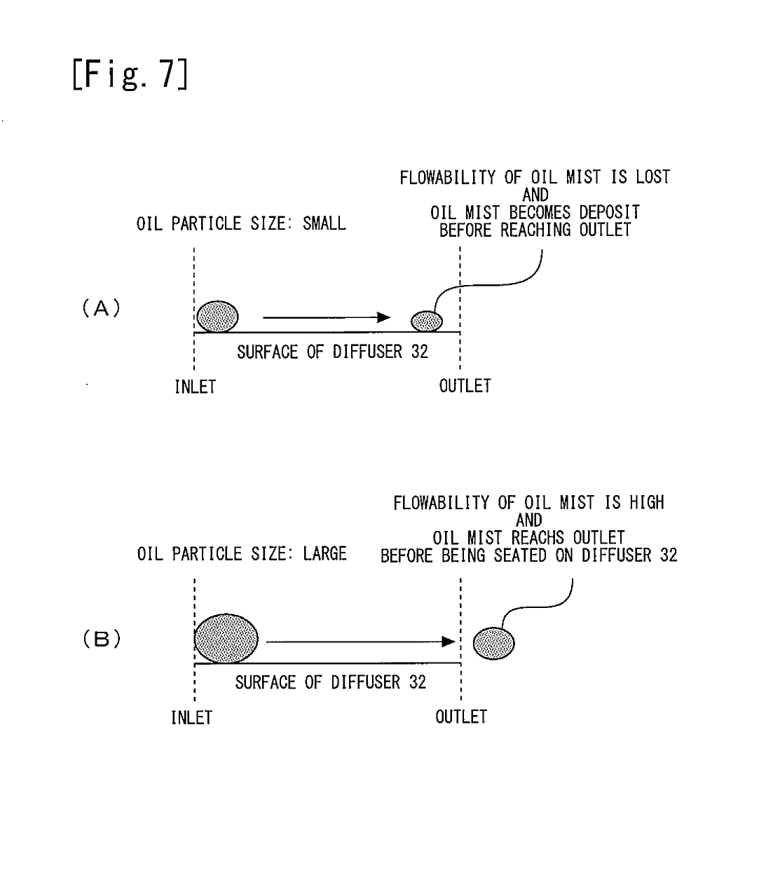

FIG. 7 is a diagram for explaining the behavior of the oil mist in the diffuser 32. As described in FIG. 6, the oil mist (the soot-containing oil) loses the oil component inside the oil mist and is reduced in the particle size, while flowing through the diffuser 32. Especially when the oil particle size in an inlet of the diffuser 32 is small, the flowability of the oil mist is lost while the oil mist is flowing and the oil mist becomes a deposit (FIG. 7 (A)). Meanwhile, when the oil particle size is large, the flowability of the oil mist is kept high, and the oil mist passes through the diffuser 32 to reach the scroll 30 side (FIG. 7 (B)). From this, it is found that if the oil particle size is large, the oil can be prevented from being seated on the surface of the diffuser 32, and the oil mist can be restrained from turning into a deposit.

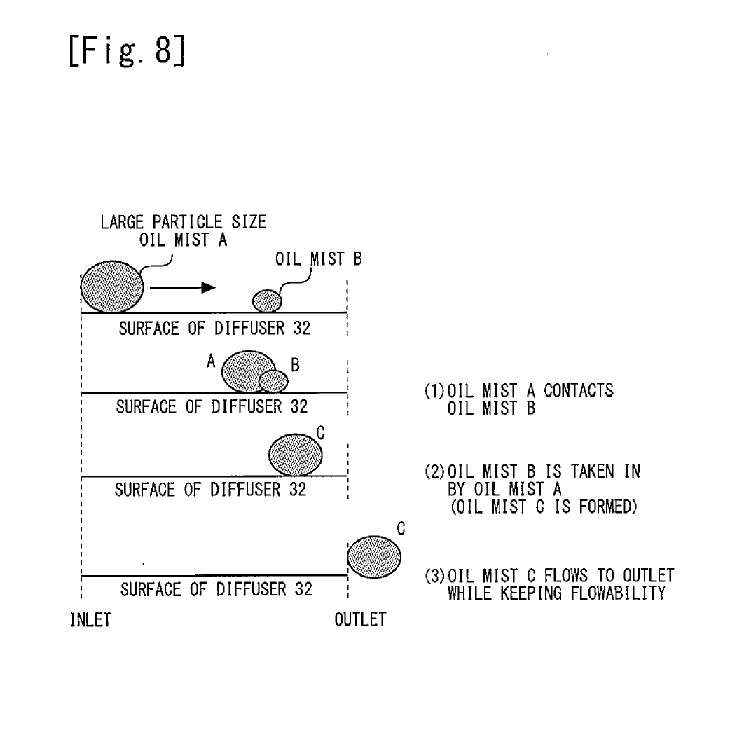

FIG. 8 is a diagram for explaining a behavior of oil mist of a large particle size (referred to the oil mist having a particle size larger than 1 μm. The same shall apply hereinafter.) in the diffuser 32. As shown in FIG. 8, when the oil mist with a large particle size (oil mist A) flows in from the inlet of the diffuser 32, the oil mist contacts oil mist (oil mist B) which is already seated or the like on the surface of the diffuser 32 ((1) in FIG. 8). Thereupon, the oil mist B is taken in by the oil mist A, and oil mist C which has a larger particle size is formed ((2) in FIG. 8). Subsequently, the oil mist C flows to an outlet of the diffuser 32 while keeping flowability ((3) in FIG. 8). From this, it is found that the oil mist with a large particle size can remove the oil mist which is seated or the like.

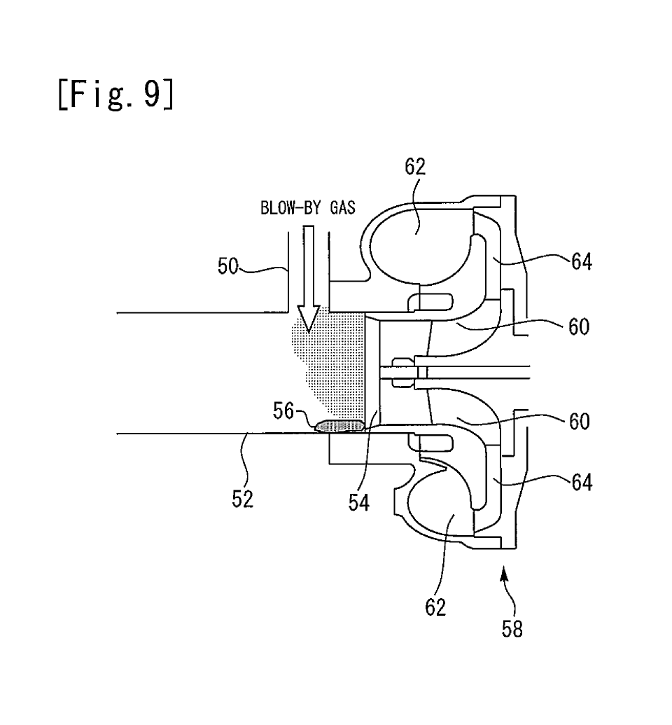

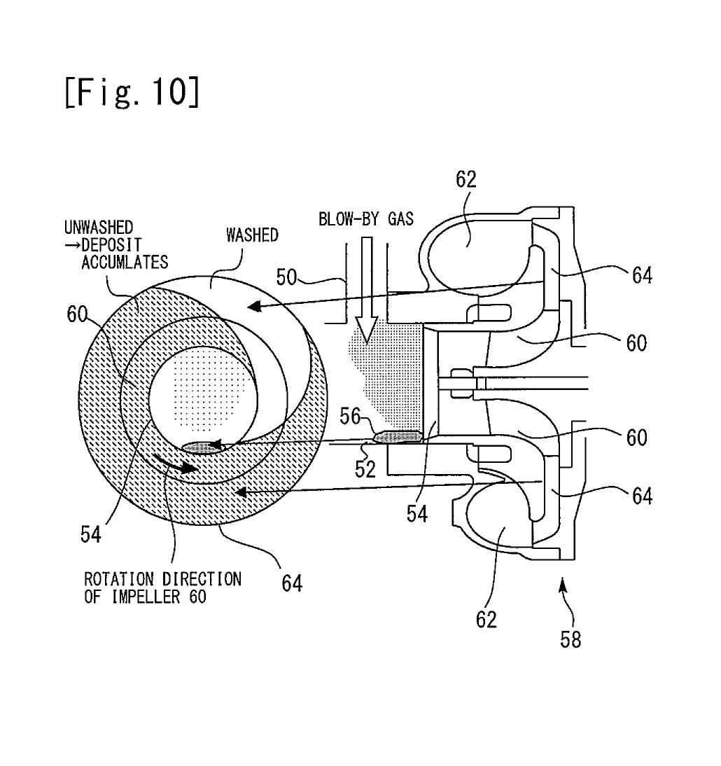

Next, with reference to FIG. 9 to FIG. 10, supplementary explanation of the effect described with FIG. 7 and FIG. 8 will be given. FIG. 9 is a view for explaining a flow of a blow-by gas and the like in a conventional intake system structure. Note that the conventional intake system structure is similar to the intake system structure of the present embodiment except that the tubular member 34 is not installed. Therefore, the detailed description concerning the components in FIG. 9 will be omitted.

As shown in FIG. 9, the blow-by gas which flows into an intake pipe 52 from a PCV pipe 50 flows to an inlet section 54 side together with an intake gas that flows in the intake pipe 52. At this time, the blow-by gas collides with an inner circumferential wall of the intake pipe 52. When the blow-by gas collides with the inner circumferential wall of the intake pipe 52, part of the oil mist in the blow-by gas is brought into a liquefied state (an oil droplet 56). The oil droplet 56 takes in oil mist in the blow-by gas which flows into the intake pipe 52 in succession, and moves to the inlet section 54 side in accordance with the flow of the intake gas while keeping the liquefied state.

FIG. 10 is a view for explaining a behavior of the oil droplet 56 inside a compressor 58. As described with FIG. 9, the oil droplet 56 moves to the inlet section 54 side in accordance with the flow of the intake gas while keeping the liquefied state. Therefore, the oil droplet 56 which flows in from the inlet section 54 flows in from a part of a surface of an impeller 60, and is discharged to a diffuser 64 side. Accordingly, as shown in FIG. 10, a surface of the diffuser 64 is washed along a locus that the oil droplet 56 draws. In other words, in the intake system structure in FIG. 9, the surface of the diffuser 64 can be washed only partially.

In this regard, the oil droplet 38 described with FIG. 3 to FIG. 5 is an aggregate of oil mist with a particle size much larger than that of the oil mist with the large particle size. Therefore, by the oil droplet 38, the oil mist which is seated on the surface of the impeller 22 and deposits can be uniformly washed. Consequently, according to the intake system structure in FIG. 2, deposit accumulation in the entire surface of the diffuser 32 can be restrained. Further, the oil droplet 38 can reach the scroll 30 side without being seated on the surface of the diffuser 32. Consequently, according to the intake system structure in FIG. 2, generation of deposits in the entire surface of the diffuser 32 can be also restrained.

Incidentally, in embodiment 1 described above, the blow-by gas is caused to collide with the tubular member 34 to generate the oil droplet 38, and the generated oil droplet 38 is caused to flow along the outer circumferential wall of the tubular member 34. However, the oil droplet 38 can be also generated and caused to flow by using means other than the tubular member 34.

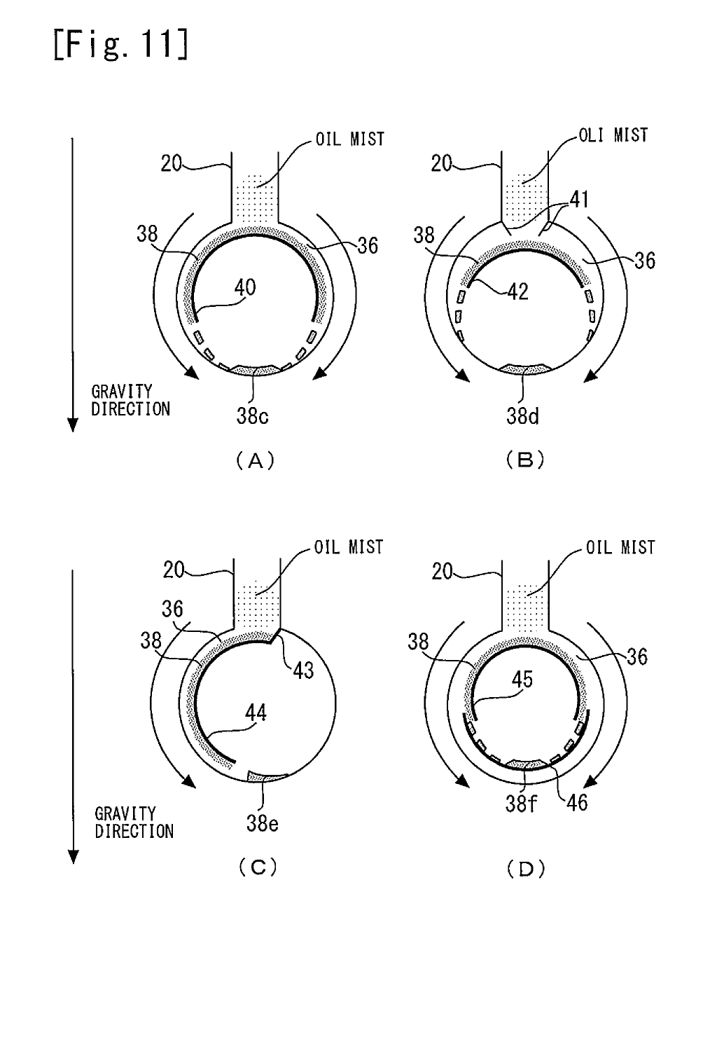

FIG. 11 is a view for explaining a modified mode of embodiment 1 described above. For example, by using a tubular member 40 in a shape formed by cutting out a lower portion in the gravity direction of the tubular member 34, in place of the tubular member 34, a blow-by gas is caused to collide with the tubular member 40 to generate the oil droplet 38, and the oil droplet 38 can be also caused to flow in such a manner as to be along the outer circumferential wall ((A) in FIG. 11). Further, for example, a gas throttle member (liquefaction promoting member) 41 that is provided at an outlet at the intake pipe 16 side, of the PCV pipe 20, can also be used in combination with a tubular member 42 including a lower portion in the vertical direction of the tubular member 34 cut out on a larger scale than the cutout of the above described tubular member 40 ((B) in FIG. 11). Note that the above described gas throttle member 41 is more specifically a member in a truncated cone tube shape, and a member in which an end portion with a large diameter is connected to a connection region of the PCV pipe 20 and the intake pipe 16, and an end portion with a small diameter is located inside the intake pipe 16. Further, for example, a gas collision member (liquefaction promoting member) 43 provided at the connection region of the PCV pipe 20 and the intake pipe 16, and a tubular member 44 formed by cutting out a substantially right half of the tubular member 34 can be used in combination ((C) in FIG. 11). Note that the above described gas collision member 43 is a member that extends from a part of the connection region of the PCV pipe 20 and the intake pipe 16 toward a center axis of the PCV pipe 20 and toward the inside of the intake pipe 16, and the above described tubular member 44 is a member that passes a lower side of an opening of the PCV pipe 20 from an end portion in the intake pipe 16, of the above described gas collision member 43 to extend to a lower region in the vertical direction of the intake pipe 16 along the inner circumferential surface of the intake pipe 16. Furthermore, a tubular member 45 having a tube diameter smaller than that of the tubular member 40, and a tubular member 46 in a shape formed by cutting out an upper portion of the tubular member 40 can be also used in combination ((D) in FIG. 11). Note that oil droplets 38c, 38d, 38e and 38f shown in FIG. 11 schematically show temporary accumulation state of the oil droplet 38. Further, in embodiment 1 described above, the tubular member 34 and the intake pipe 16 are disposed so that center axes of both of them correspond to each other. However, these center axes do not always have to correspond to each other. Namely, as shown in (B) in FIG. 11, the tubular member 34 and the intake pipe 16 may be disposed so that the center axis of the tubular member 34 is at a lower side in the gravitation direction with respect to the center axis of the intake pipe 16.

As above, any means that can cause oil to flow along the inner circumferential wall of the intake pipe 16 while enlarging the particle size of the oil in the blow-by gas can be used in place of the tubular member 34 of embodiment 1 described above. Note that the present modification can be similarly applied in respective embodiments which will be described later.

Further, in embodiment 1 described above, explanation is made with the system including the turbocharger 12 as a premise. However, the intake system structure of embodiment 1 described above can be similarly applied in a system which is not loaded with a turbocharger. Namely, in the light of the generation mechanism of deposits, it can be said that when soot-containing oil is exposed under a high-temperature environment, the soot-containing oil easily turns into a deposit. Therefore, even in the system which is not loaded with a turbocharger, if the tubular member 34 of embodiment 1 described above is disposed in the vicinity of an intake valve (for example, an intake manifold and an intake pipe upstream of the intake manifold), the vicinity of the intake valve can be uniformly washed by the oil droplet 38. Accordingly, generation or accumulation of deposits in the vicinity of the intake valve can be restrained. Note that the present modification can be similarly applied in the respective embodiments which will be described later.

Note that in embodiment 1 described above and the modified mode thereof, the tubular members 34 and 40, the combination of the gas throttle member 41 and the tubular member 42, the combination of the gas collision member 43 and the tubular member 44, and the combination of the tubular members 45 and 46 correspond to “particle size enlargement oil flowing means” in the above described first invention.

Further, while in embodiment 1 described above, a sectional shape perpendicular to the center axis of the tubular member 34 is circular, the sectional shape may be oval, polygonal (for example, pentagonal, hexagonal and the like).

Further, in embodiment 1 described above and the modified mode thereof, the tubular members 34, 40, 42, 44 and 45 correspond to “intake pipe internal member” in the above described second invention.

### Embodiment 2

### Feature of Embodiment 2

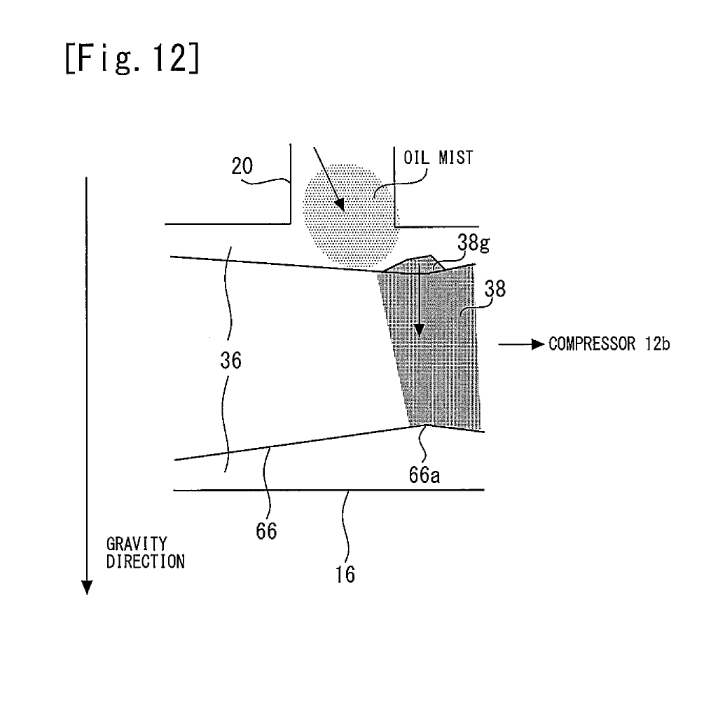

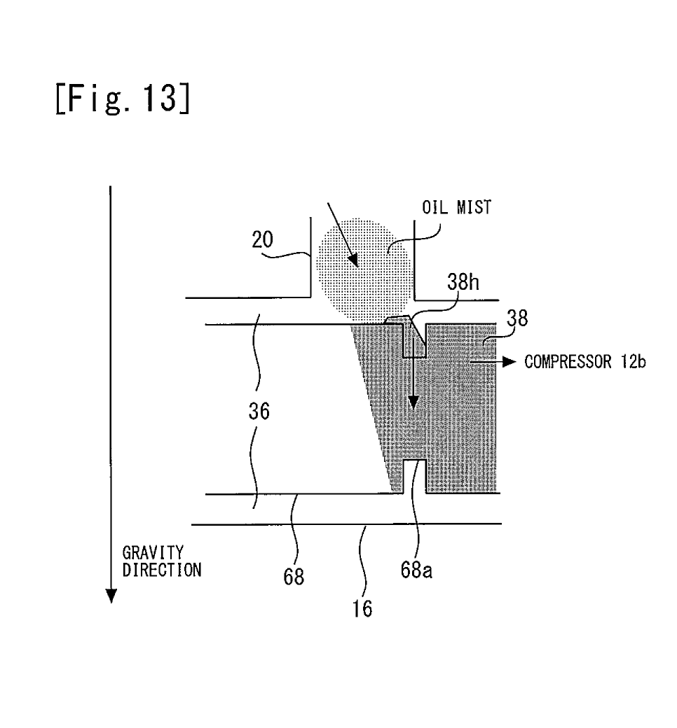

Next, with reference to FIG. 12 and FIG. 13, embodiment 2 of the present invention will be described. In the present embodiment, a feature thereof is a point in that the tubular member 34 of embodiment 1 described above is replaced with a tubular member 66 shown in FIG. 12. Therefore, hereinafter, the feature part is mainly described, and the system configuration and the other contents which are already described in embodiment 1 described above will be omitted.

FIG. 12 is a view for explaining the feature part of the tubular member in embodiment 2, and an effect by the feature part. As shown in FIG. 12, the tubular member 66 is disposed inside the intake pipe 16. Therefore, the oil droplet 38 can be generated in an outer circumferential wall of the tubular member 66. Further, as shown in FIG. 12, the PCV pipe 20 connects to the intake pipe 16 from above in the gravity direction. Therefore, the generated oil droplet 38 flows down on the outer circumferential wall of the tubular member 66 in accordance with the gravity, and diffuses to the entire outer circumferential wall while keeping a liquefied state.

Here, in the tubular member 66, a tube port reduction section 66a is formed halfway in the tubular member 66. Therefore, in the tube port reduction section 66a, movement of the oil droplet 38 in a direction of the compressor 12b is restrained, and movement in the gravity direction (the arrow direction in the drawing) can be promoted. Thereby, a temporary accumulation state is generated (an oil droplet 38g) in the tube port reduction section 66a, and the oil droplet 38g can be caused to flow along the tube port reduction section 66a. Therefore, the oil droplet 38 can be spread over the entire outer circumferential wall of the tubular member 66. In this regard, the tubular member 34 of embodiment 1 described above is a member in a straight-tube shape, and therefore, the oil droplet 38 is likely to be taken into the compressor 12b before the oil droplet 38 spreads over the entire outer circumferential wall of the tubular member 34.

As above, according to the tubular member 66 of the present embodiment, the oil droplet 38g in an accumulationstate is caused to flow along an outer circumference of the tube port reduction section 66a, and the oil droplet 38 can be reliably spread over the entire outer circumferential wall of the tubular member 66. Accordingly, the oil droplet 38 can be brought into contact with the surface of the diffuser 32 in a more uniform state. Accordingly, generation or accumulation of the deposits on the surface of the diffuser 32 can be restrained more effectively.

Incidentally, while in embodiment 2 described above, the tubular member 66 where the tube port reduction section 66a is formed is used, a tubular member where work other than the tube port reduction section 66a is applied can be also used. FIG. 13 is a view for explaining a modified mode of embodiment 2 described above. For example, a tubular member 68 where a groove section 68a is formed can be also used, in place of the tubular member 66. Note that the groove section 68a is formed to extend around an outer circumferential wall of the tubular member 68. According to the tubular member 68, the accumulation state of the oil droplet 38 is generated (an oil droplet 38h) in the groove section 68a, and the oil droplet 38h can be caused to flow along the groove section 68a. Therefore, the oil droplet 38 can be spread over the entire outer circumferential wall of the tubular member 68. Accordingly, an effect substantially similar to the effect of embodiment 2 described above can be obtained.

Note that in embodiment 2 described above and the modified mode thereof, the tube port reduction section 66a and the groove section 68a correspond to “flowability reducing means” in the above described third invention.

### Embodiment 3

### Feature of Embodiment 3

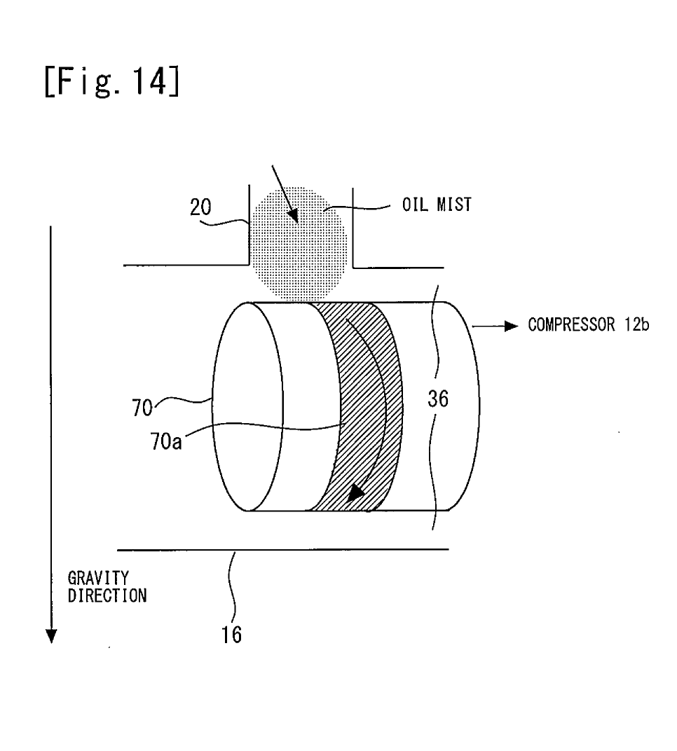

Next, with reference to FIG. 14, embodiment 3 of the present invention will be described. In the present embodiment, a feature thereof is a point in that the tubular member 34 of embodiment 1 described above is replaced with a tubular member 70 shown in FIG. 14. Therefore, hereinafter, the feature part will be mainly described, and the system configuration and the other contents which are already described in embodiment 1 described above will be omitted.

FIG. 14 is a view for explaining the feature part of the tubular member in embodiment 3, and an effect by the feature part. As shown in FIG. 14, the tubular member 70 is disposed inside the intake pipe 16. The tubular member 70 is a tubular member in a straight tube shape similar to the tubular member 34 in FIG. 2. Therefore, an oil droplet (not illustrated) can be generated in an outer circumferential wall of the tubular member 70, and can be caused to flow on the outer circumferential wall.

Further, as shown in FIG. 14, a coating section 70a formed from a lipophilic material is formed at a midpoint (more specifically, a portion immediately downstream of the connection port to the PCV pipe 20) on the outer circumferential wall of the tubular member 70. Note that the coating section 70a is formed to extend in a band shape around the outer circumferential wall of the tubular member 70 with a center axis of the tubular member 70 as a center. Therefore, in the coating section 70a, movement of an oil droplet in the direction of the compressor 12b is restrained, and movement in the gravity direction (the arrow direction in the drawing) can be promoted. Thereby, a temporary accumulation state of the oil droplet is generated in the coating section 70a, and the oil droplet can be caused to flow along the coating section 70a. Therefore, the oil droplet can be spread over the entire outer circumferential wall of the tubular member 70. Consequently, according to the tubular member 70 of the present embodiment, an effect substantially similar to embodiment 2 described above can be obtained.

Incidentally, in embodiment 3 mentioned above, the tubular member 70 where the coating section 70a is formed is used, however, instead of forming the coating section 70a, the outer circumferential wall of the coating section formation spot may be formed by a rough surface. As above, any means that can generate a temporary accumulation state of an oil droplet can be used in place of the tubular member 70 of embodiment 3 described above. Note that the present modification also can be similarly applied in embodiment 4 which will be described later.

Note that in embodiment 3 described above and the modified mode thereof, the coating section 70a corresponds to “flowability reducing means” in the above described third invention.

### Embodiment 4

### Feature of Embodiment 4

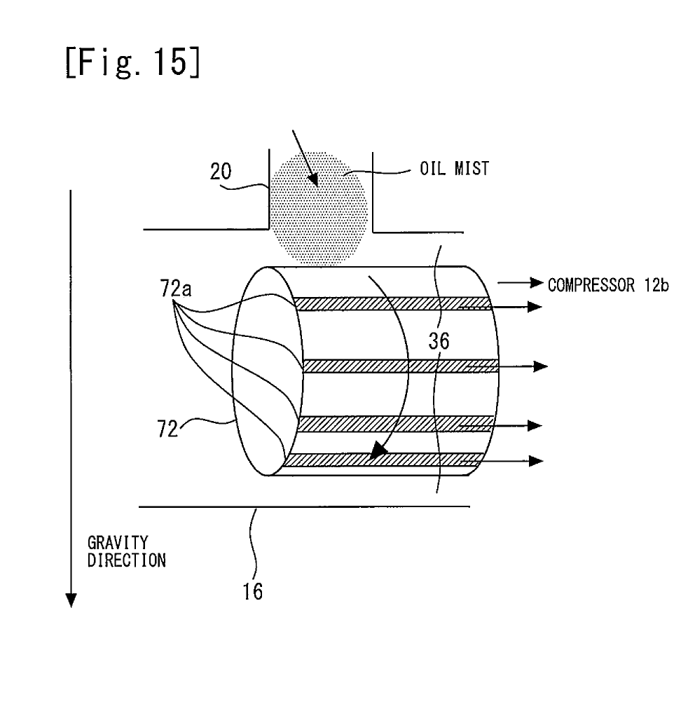

Next, with reference to FIG. 15, embodiment 4 of the present invention will be described. In the present embodiment, a feature thereof is a point in that the tubular member 34 of embodiment 1 described above is replaced with a tubular member 72 shown in FIG. 15. Therefore, hereinafter, the feature part will be mainly described, and the system configuration and the other contents which are already described in embodiment 1 described above will be omitted.

FIG. 15 is a view for explaining the feature part of the tubular member in embodiment 4, and an effect by the feature part. As shown in FIG. 15, the tubular member 72 is disposed inside the intake pipe 16. The tubular member 72 is a member in a straight tube shape similar to the tubular member 34 in FIG. 2. Therefore, an oil droplet (not illustrated) can be generated in an outer circumferential wall of the tubular member 72, and can be caused to flow on the outer circumferential wall.

Further, as shown in FIG. 15, on the outer circumferential wall of the tubular member 72, coating sections 72a composed of a lipophilic material are formed along a gas flow direction. The coating sections 72a are formed with predetermined spaces in a circumferential direction of the tubular member 72, and among the respective coating sections 72a, the outer circumferential wall itself of the tubular member 72 is exposed. Namely, it can be said that on the outer circumferential wall of the tubular member 72, regions with high lipophilicity (the coating sections 72a) and regions with low lipophilicity (the outer circumferential wall of the tubular member 72) are alternately formed. By forming the tubular member like this, oil mobility to the regions with low lipophilicity from the regions with high lipophilicity is reduced, and oil accumulations can be generated in the regions with high lipophilicity. Further, since the oil accumulation has mass, the oil accumulation flows downward after a certain amount of oil is accumulated. Accordingly, oil accumulations are formed at predetermined spaces in the circumferential direction of the outer circumferential wall of the tubular member 72.

As above, according to the tubular member 72 of the present embodiment, by a combination of the regions with high lipophilicity and the regions with low lipophilicity, the effects of the tubular members of embodiments 1 to 3 described above can be further enhanced. Namely, since the tubular member 34 of embodiment 1 described above is a member in a straight tube shape, the oil droplet 38 is likely to be taken into the compressor 12b before the oil droplet 38 spreads over the entire outer circumferential wall of the tubular member 34. Further, with the tubular members 66, 68 and 70 of embodiments 2 and 3 described above, the particle size of the oil droplet 38 in the accumulation state becomes excessively large, and the oil droplet 38 is likely to reach the inner circumferential wall of the intake pipe 16 at an opposite side to the connection port to the PCV pipe 20.

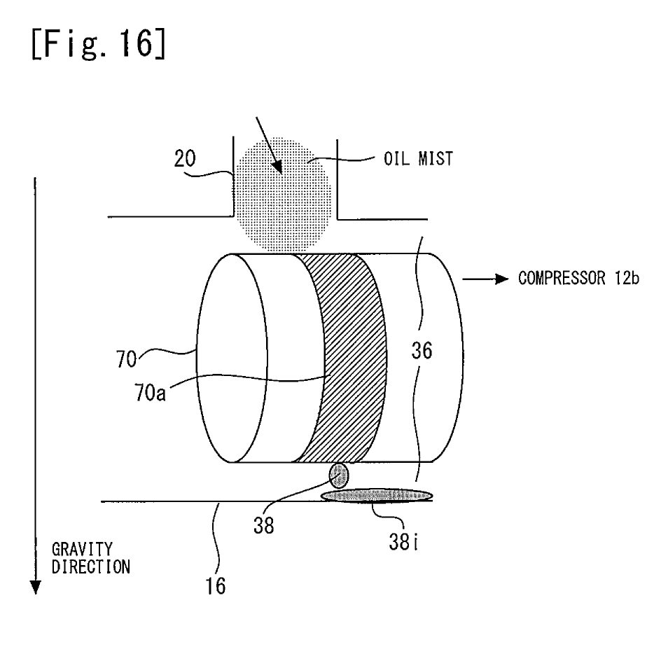

FIG. 16 is a view for explaining a problem of the tubular member 70 of embodiment 3 described above. As shown in FIG. 16, on the outer circumferential wall of the tubular member 70, the coating section 70a is formed. Therefore, the oil droplet 38 can be caused to flow along the coating section 70a. However, when the oil droplet 38 finishes flowing on the coating section 70a before being taken into the compressor 12b, the oil droplet 38 is likely to accumulate on the inner circumferential wall of the intake pipe 16 as an oil droplet 38i. In that case, the oil droplet 38i flows into the compressor 12b from a part of the impeller 22, and therefore, the oil droplet 38i can only partially wash the surface of the diffuser 32.

In this regard, according to the tubular member 72 of the present embodiment, owing to the disposition of the coating sections 72a as mentioned above, the generation amount of the oil droplet 38i described with FIG. 16 can be reduced. Accordingly, the oil droplet 38 can be more effectively brought into contact with the surface of the diffuser 32 uniformly.

Incidentally, while in embodiment 4 described above, the tubular member 72 where the coating sections 72a are formed is used, a tubular member where groove sections are formed may be used, instead of the coating sections 72a. If the groove sections are formed along the gas flow direction, and the groove portions are formed at predetermined spaces in the circumferential direction of the tubular member, temporary oil accumulations can be generated in the groove sections. Accordingly, an effect substantially similar to the effect of embodiment 4 described above can be obtained.

Note that in embodiment 4 described above and the modified mode thereof, the coating section 72a corresponds to “flowability reducing means” in the above described fourth invention.

### Embodiment 5

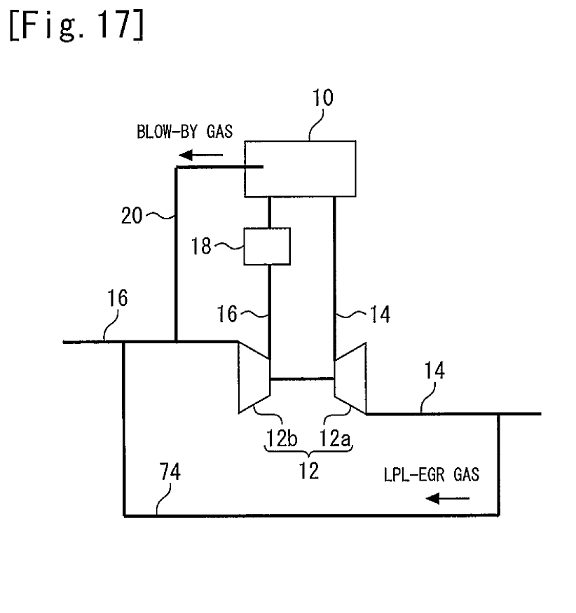

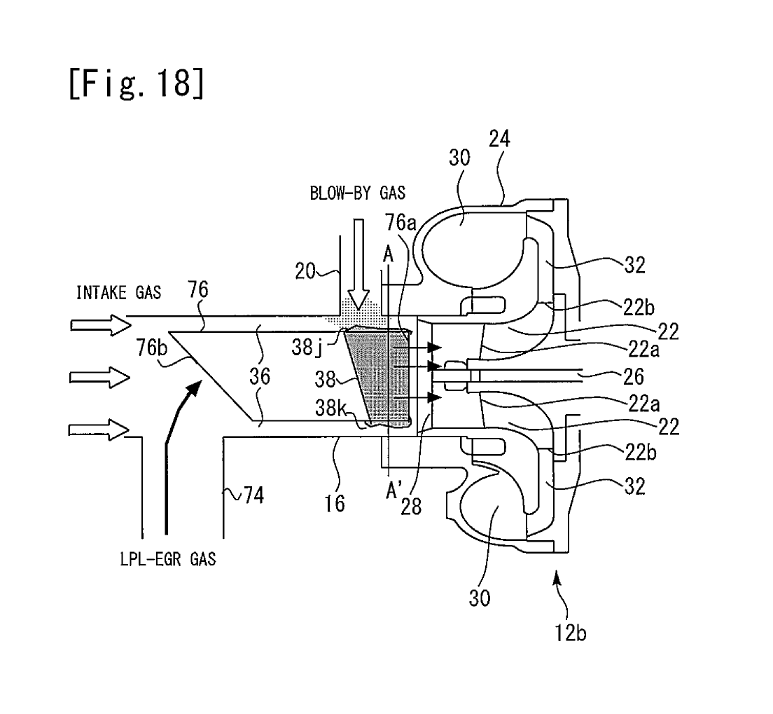

Next, with reference to FIG. 17 to FIG. 20, embodiment 5 of the present invention will be described. The present embodiment has a feature of adopting an intake system structure in FIG. 18 in a system configuration in FIG. 17.

### [Explanation of System Configuration]

FIG. 17 is a diagram for explaining the system configuration of embodiment 5. As shown in FIG. 17, the system of the present embodiment includes an LPL-EGR mechanism that introduces an LPL-EGR (Low Pressure Loop Exhaust Gas Recirculation) gas. The LPL-EGR mechanism includes a LPL-EGR pipe 74. The LPL-EGR pipe 74 connects the exhaust pipe 14 at the downstream side from the turbine 12a, and the intake pipe 16 at the upstream side from the connection region of the PCV pipe 20 and the intake pipe 16. The configuration other than the LPL-EGR mechanism is similar to embodiment 1 described above, and therefore, explanation thereof will be omitted.

### Feature of Embodiment 5

Next, with reference to FIG. 18 to FIG. 20, the feature of the present embodiment will be described. First, with reference to FIG. 18, an intake system structure corresponding to the feature part of the present embodiment, and a flow of a blow-by gas and the like in the intake system structure will be described. FIG. 18 is an enlarged sectional view of a vicinity of the compressor 12b in FIG. 17. As shown in FIG. 18, a tubular member 76 is disposed inside the intake pipe 16. The tubular member 76 is a tubular member in a straight tube shape similar to the tubular member 34 in FIG. 2. Therefore, the oil droplet 38 is generated on the outer circumferential wall of the tubular member 76, and is caused to flow on the outer circumferential wall. Note that oil droplets 38j and 38k shown in FIG. 18 schematically show temporary accumulation states of the oil droplet 38.

A downstream end 76a of the tubular member 76 is disposed to face the inlet section 28. Therefore, the blow-by gas flows into the intake pipe 16 from the PCV pipe 20, flows in such a manner as to be along the outer circumferential wall (namely, the inner circumferential wall of the intake pipe 16) of the tubular member 76 together with the intake gas which flows in the gap 36, and heads toward the inlet section 28. Meanwhile, an upstream end 76b of the tubular member 76 inclines to the LPL-EGR pipe 74 side. Namely, an upstream end opening of the tubular member 76 opens toward an opening of the LPL-EGR pipe 74 to the intake pipe 16. Therefore, most of the LPL-EGR gas flows into the tubular member 76, and heads toward the inlet section 28 together with the intake gas.

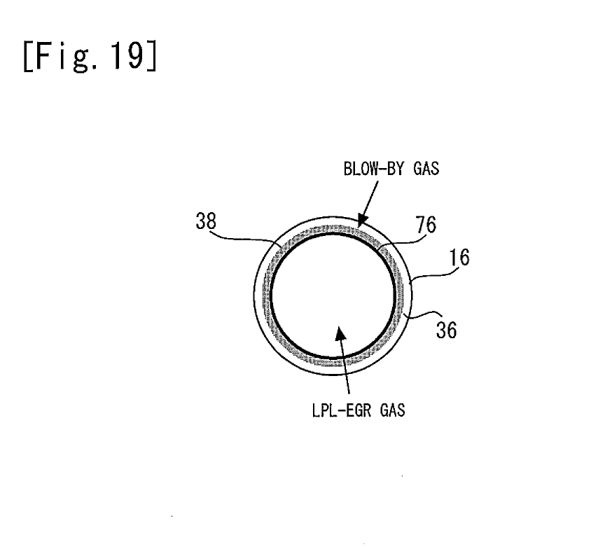

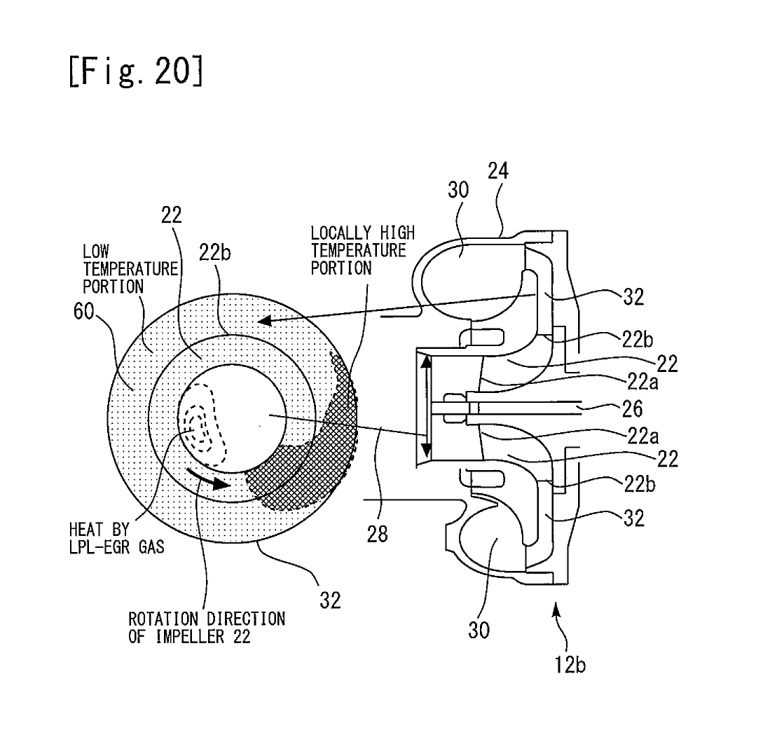

Next, an effect by the intake system structure in FIG. 18 mentioned above will be described with reference to FIG. 19 to FIG. 20. FIG. 19 is a sectional view taken along line A-A′ of FIG. 18. As shown in FIG. 19, the blow-by gas flows in the gap 36, and the LPL-EGR gas flows inside the tubular member 76. Here, the LPL-EGR gas is a gas at a high temperature (approximately 90° C.). Accordingly, the temperature of the intake gas (namely, an EGR gas-containing gas) at the time of reaching the discharge side 22b of the impeller 22 is a temperature higher than the gas temperature at the time of an ordinary intake gas (namely, air) reaching the discharge side 22b. Therefore, when the blow-by gas and the LPL-EGR gas mix with each other before flowing into the compressor 12b, reduction in the particle size and increase in viscosity of the soot-containing oil advance in the vicinity of the inlet section 28, and the soot-containing oil is deposited on the surface of the diffuser 32 with a high probability. In this regard, according to the intake system structure in FIG. 18, the gases can be restrained from mixing before flowing into the compressor 12b.

FIG. 20 is a view showing a temperature distribution inside the compressor 12b at the time of introduction of the LPL-EGR gas in the configuration which is not provided with the tubular member 76. As described above, the LPL-EGR gas has a high temperature, and therefore, on the surface of the diffuser 32, a locally high temperature portion is formed along the gas flow of the LPL-EGR gas. In this regard, according to the intake system structure in FIG. 18, oil mist (soot-containing oil) flows in so as to be along the outer circumferential wall of the tubular member 76, and the LPL-EGR gas flows into the compressor 12b from the inside of the tubular member 76. Therefore, mixing of the soot-containing oil and the locally high temperature portion can be also reduced inside the compressor 12b. Consequently, according to the intake system structure in FIG. 18, the washing effect by the oil droplet 38 can be exhibited while mixing of the soot-containing gas and the LPL-EGR gas is restrained.

Note that in embodiment 5 described above, the tubular member 76 corresponds to the “internal piping” in the above described sixth invention.

### DESCRIPTION OF REFERENCE NUMERALS

10 engine
12 turbocharger
12a turbine
12b compressor
16, 52 intake pipe
20, 50 PCV pipe
22, 60 impeller
22a intake side
22b discharge side
32, 64 diffuser
34, 40, 42, 44, 45, 66, 68, 70, 76 tubular member
34a, 76a downstream end
36 gap
38, 56 oil droplet
41 gas throttle member
43 gas collision member
66a tube port reduction section
68a groove section
70a, 72a coating section
74 LPL-EGR pipe
76b upstream end

1. An internal combustion engine, comprising:
a compressor that is provided at an intake pipe of the internal combustion engine and, compresses a gas flowing in the intake pipe;
a PCV pipe that introduces a blow-by gas containing oil into an upstream side of the compressor in the intake pipe; and
particle size enlargement oil flowing means for enlarging a particle size of the oil in the blow-by gas introduced into the intake pipe from the PCV pipe, and causing the oil having the particle size enlarged to flow along an inner circumferential wall of the intake pipe.

2. The internal combustion engine according to claim 1,
wherein the particle size enlargement oil flowing means comprises an intake pipe internal member having an outer circumferential wall in a curved shape that is disposed on a blow-by gas passage in which the blow-by gas introduced into the upstream side of the compressor flows,
the PCV pipe is connected to the intake pipe from above in a vertical direction, and
an opening of the PCV pipe to the intake pipe, and the outer circumferential wall are disposed to face each other.

3. (canceled)

4. The internal combustion engine according to claim 2,
wherein flowability reducing means that reduces flowability on the outer circumferential wall, of the oil in the blow-by gas introduced into the upstream side of the compressor is provided at the outer circumferential wall.

5. The internal combustion engine according to claim 4,
wherein the flowability reducing means is a plurality of means that extends in an upstream and downstream directions of the intake pipe, and are spaced from one another in a circumferential direction of the outer circumferential wall.

6. The internal combustion engine according to claim 2, further comprising:
an EGR pipe that introduces an EGR gas into the intake pipe from an upstream side from an opening of the PCV pipe to the intake pipe,
wherein the intake pipe internal member is an internal piping with a smaller diameter than the intake pipe, and
an upstream end opening of the internal piping opens toward an opening of the EGR pipe to the intake pipe.

7. An internal combustion engine, comprising:
a compressor that is provided at an intake pipe of the internal combustion engine and, compresses a gas flowing in the intake pipe;
a PCV pipe that introduces a blow-by gas containing oil into an upstream side of the compressor in the intake pipe; and
a particle size enlargement oil flowing device for enlarging a particle size of the oil in the blow-by gas introduced into the intake pipe from the PCV pipe, and causing the oil having the particle size enlarged to flow along an inner circumferential wall of the intake pipe.

8. The internal combustion engine according to claim 7,
wherein the particle size enlargement oil flowing device comprises an intake pipe internal member having an outer circumferential wall in a curved shape that is disposed on a blow-by gas passage in which the blow-by gas introduced into the upstream side of the compressor flows,
the PCV pipe is connected to the intake pipe from above in a vertical direction, and
an opening of the PCV pipe to the intake pipe, and the outer circumferential wall are disposed to face each other.

9. The internal combustion engine according to claim 8,
wherein a flowability reducing device that reduces flowability on the outer circumferential wall, of the oil in the blow-by gas introduced into the upstream side of the compressor is provided at the outer circumferential wall.

10. The internal combustion engine according to claim 9,
wherein the flowability reducing device includes a plurality of sections that extend in an upstream and downstream directions of the intake pipe, and are spaced from one another in a circumferential direction of the outer circumferential wall.

11. The internal combustion engine according to claim 8, further comprising:
an EGR pipe that introduces an EGR gas into the intake pipe from an upstream side from an opening of the PCV pipe to the intake pipe,
wherein the intake pipe internal member is an internal piping with a smaller diameter than the intake pipe, and
an upstream end opening of the internal piping opens toward an opening of the EGR pipe to the intake pipe.
